(19) United States
(12) Patent Application Publication
(10) Pub. No.: US 2011/0107513 A1
(43) Pub. Date: May 12, 2011

(54) APPARATUS AND METHOD FOR FACILITATING MIXING OF A FLUID

(76) Inventor: Ng Ghee Tjia, Singapore (SG)

(21) Appl. No.: 12/937,214

(22) PCT Filed: Apr. 7, 2009
(86) PCT No.: PCT/SG2009/000130

§ 371 Date: Nov. 19, 2010

(30) Foreign Application Priority Data
Apr. 8, 2008 (SG) 200802707-0

(51) Int. Cl. B67D 7/74; B67D 7/06; B67D 7/80; A47K 3/28

(52) U.S. Cl. 4/597; 222/144.5; 222/146.2; 4/903; 239/315

(57) ABSTRACT

An apparatus for facilitating mixing of a fluid, the apparatus comprising a first fluid channel in fluid communication with a mixing chamber for mixing the fluid with an agent, wherein the mixing chamber includes a dispenser to dispense the agent into the mixing chamber.

### FIELD OF THE INVENTION

This invention relates to an apparatus and method for facilitating mixing of a fluid. More particularly, the present invention relates to an apparatus for facilitating mixing of a fluid with an agent for use in aromatherapy, hydrotherapy, and showering.

### BACKGROUND OF THE INVENTION

People use various approaches to promote wellness, well-being, and therapeutic approaches to illness, including the use of agents to be sensed or detected by olfaction. People also make use of water, e.g., hydrotherapy, to help promote body well being, or to help address the symptoms of a cold or other such illness.

For example, aromatherapy is the use of essences of plants processed as essential oils for therapeutic benefits such as, for example, attaining balance in human body, enhancing the immunity system, preventing or minimizing illnesses, calming nerves, enhancing attention spans, and so forth.

However, aromatherapy is not solely reliant on the sense of smell. The essential oils used in aromatherapy consist of constituents such as esters, phenols, or the like which provide respective therapeutic effects. Each essential oil has a unique combination of constituents, which interact with the body. The interaction with the constituents provides beneficial effects for the body. For example, one beneficial effect is improvement of blood circulation and relaxation of tired muscles when essential oils are used in massage.

Common techniques used for aromatherapy are:
Massaging of essential oil onto desired body part(s);
Hot/Cold Compress: Application of a compress to the desired body part(s) with appropriate amounts of essential oils added to the compress maintained at a preferred temperature. A compress may be, for example, a cloth soaked with hot or cold water, mixed with essential oils, which is pressed onto an affected part of the body, such as ankle or knees. Another example of a compress is a medicated plaster.
Inhaling essential oils by vaporizing the oils using hot water in a basin or bowl;
Inhaling essential oils by vaporizing the oils using aroma burners;
Taking baths with drops of essential oils added to the water; and
Direct inhalation from an absorbent material with drops of essential oils added to the absorbent material.

Aromatherapy may be used in spa treatments, where people soak in baths mixed with aroma oils for relaxation, to relieve stress and to benefit from the therapeutic properties of aromatherapy. Other treatments in spas, such as mud-wraps, weight-reduction programs also rely on the use of aromatherapy.

A single session in a spa may take about 1 to 2 hours or longer. After the session, a user will normally have a shower with clean water to rinse off any residue from soaking in the bath mixed with essential or aroma oils. Consumers who lead a fast pace of life may consider a spa session time consuming. It is also expensive to seek spa treatments on a regular basis.

In the home, if the consumers wish to use essential oils in the bath, a bath tub would be required. In homes, which do not have a bath tub, the consumers would have to go to a spa.

Hence, there is a need to provide an alternative to conventional spas for aromatherapy, medical therapies, ritual baths or the like which is less time consuming and more economical, yet achieve the same therapeutic and beneficial properties of a spa.

### SUMMARY OF THE INVENTION

In accordance with a firM aspect of the invention, there is provided an apparatus for facilitating mixing of a fluid, the apparatus comprising a first fluid channel in fluid communication with a mixing chamber for mixing the fluid with an agent, wherein the mixing chamber includes a dispenser to dispense the agent into the mixing chamber.

By “fluid”, it is meant to include a state of matter in which only a uniform isotropic pressure can be supported without indefinite distortion, for example, a gas including oxygen or the like or a liquid including water or the like.

By “agent”, it is meant to include any gas, liquid or solid that may be sensed through olfaction. Where the agent is a fluid, the agent may be a fluid selected from the group consisting of: essential oils, hydrolates, fragrance oils, infused oils, perfumes and hydrosols.

By “hydrolate”, it is meant to include the final water by-product left over after the steam distillation of a plant has been completed. When a hydrolate first comes off the still, and often for some time afterward, it will be slightly milky, owing to the quantity and nature of the various plant substances and essential oils dissolved in the water.

By “hydrosols”, it is meant to include condensate water co-produced during the steam- or hydro-distillation of plant material for aroma-therapeutic purposes. Usually the distillation is undertaken is undertaken to obtain the essential oils contained in the plant material, but occasionally the distillation is undertaken specifically to produce the plant water that results.

By “mixing”, it is meant to include any release, transmission, delivery, intermingling or blending of one or more agents with a fluid. Where the agent is a solid, mixing of fluid with the solid agent means the mixing of fluid with salt, herbs or other solids. For example, when salt is dissolved (mixed) in the fluid, the mixed fluid possesses the “essence” of the salt. Where the solid agent is not soluble in the fluid, such as, for example, herbs or flowers mixed in the fluid, the mixed fluid possesses the “essence” of the herbs or flowers.

By “mixing chamber”, it is meant to include any space, part of a channel, compartment, cavity, channel, or the like that allows mixing.

By “dispenser”, it is meant to include any feature that introduces an agent into a mixing chamber.

Where the agent is a fluid which is of different viscosity or density or where the agent is not soluble in a fluid such as water, mixing means that the agent is not dissolved in the water, for example, in spa baths, essential oil droplets are mixed in the baths. The essential oil droplets float in the water and is transported by the water to the user, therefore the water has the essential oil droplets, which make the shower different from a normal water shower. Advantageously, the user enjoys a scented shower as a result from the essential oil droplets present in the water.

Preferably, the apparatus further comprises a second fluid channel and a fluid channel selector to select the flow of fluid to the first or second fluid channel.

Advantageously, a user of the apparatus will have the option of having mixed flow, i.e. fluid mixed with the agent or non-mixed flow, i.e. fluid that is not mixed with the agent.

Preferably, the fluid channel selector is a valve about a fluid inlet from a first position to a second position, the first position allows fluid flow to the first fluid channel and the second position allows flow to the second fluid channel.

Preferably, the first fluid channel is intermediate the fluid channel selector and the mixing chamber.

Preferably, the dispenser includes an absorbent member for containing the agent dispensed by the dispenser, the absorbent member in contact with the fluid in the mixing chamber.

Preferably, the absorbent member is made from a material selected from the group consisting of: sponge, fabric, cotton, paper and absorbent polymers.

Preferably, the agent in the dispenser is dispensed into the mixing chamber by an electronic means. The dispenser may include any mechanical device that provides a plunging or thrusting motion to dispense the agent.

Preferably, the electronic means comprises a timer and a presser electrically connected to the timer to dispense the agent at predetermined intervals.

Preferably, the mixing chamber comprises a plurality of dispensers; each dispenser dispenses a different agent.

Preferably, the agent is selected from the group consisting of: essential oils, hydrolates, fragrance oils, infused oils, perfumes, hydrosols, liquid, vitamins, healthcare supplements, milk, beer, champagne.

Preferably, the first fluid channel further comprises a valve for preventing the agent or fluid mixed with the agent in the first fluid channel from entering the second fluid channel.

Preferably, an outlet of the apparatus is releasably attached to a shower head, and fluid exits the apparatus and into the shower head. Fluid that exits the shower head to be directed to a user as intended.

Preferably, the apparatus further comprises a heating element to heat the fluid to be mixed or introduced into the mixing chamber.

Alternatively, the apparatus is incorporated into a water heater wherein the fluid to be mixed or introduced into the apparatus may be heated by the water heater.

Preferably, an outlet of the apparatus is releasably attached to a shower head.

Preferably, the outlet of the apparatus is releasably attached to a shower head by a hose.

Preferably, the first fluid channel comprises a housing to house an agent for mixing with the fluid.

Preferably, the agent is selected from a group consisting of: herbs, flowers, Epsom salts, shower salt, bath mixtures, pH levels compounds, activated carbon, vitamins.

Preferably, the agent is retained in the housing when the fluid flows through the housing.

In accordance with a second aspect of the invention, there is provided a method for providing a shower using the apparatus according with a first aspect of the invention.

Advantageously, the present invention provides an aromatic shower in the convenience of the home to brighten up one's day, relieving stress or anxiety, and/or balancing one's immune system.

Advantageously, the present invention enables a user to create his or her own personal aromatherapy experience by selecting the agents for mixing with the fluid in accordance to his or her moods or desires.

### BRIEF DESCRIPTION OF THE DRAWINGS

In order that the present invention may be fully understood and readily put into practical effect, there shall now be described by way of non-limitative example only preferred embodiments of the present invention, the description being with reference to the accompanying illustrative drawings.

In the drawings:

FIG. 1 is a block diagram of an embodiment of the present invention in use with the conventional showering unit.

FIG. 2 illustrates a top view of the embodiment of the present invention;

FIG. 3 illustrates a side view of the embodiment of the present invention;

FIG. 4 illustrates the dispenser of the embodiment of the present invention.

FIG. 5 is a top view of an embodiment of the present invention;

FIGS. 6, 7 show an embodiment of the present invention in a mixed flow mode and a non-mixed flow mode respectively;

FIG. 8 is a perspective view of the embodiment; and

FIG. 9 is an embodiment of the present invention.

### DETAILED DESCRIPTION OF THE PREFERRED EMBODIMENTS

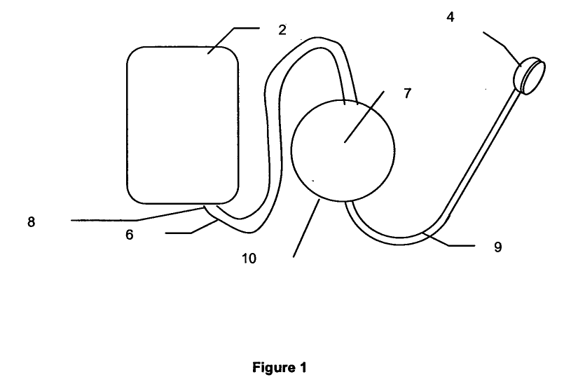

FIG. 1 shows an apparatus 10 according to a first embodiment in use in the conventional showering unit 2 having a shower head 4. A first hose 6 connects the apparatus 10 to a water outlet 8 of the showering unit 2. The apparatus 10 is connected to the shower head 4 via a second hose 9. The apparatus 10 may comprise a cover 7. The cover 7 may be used for marketing, advertising or cosmetic purposes such as for example, printing of decorative features such as company logo or installation of light devices for operation indications or the like.

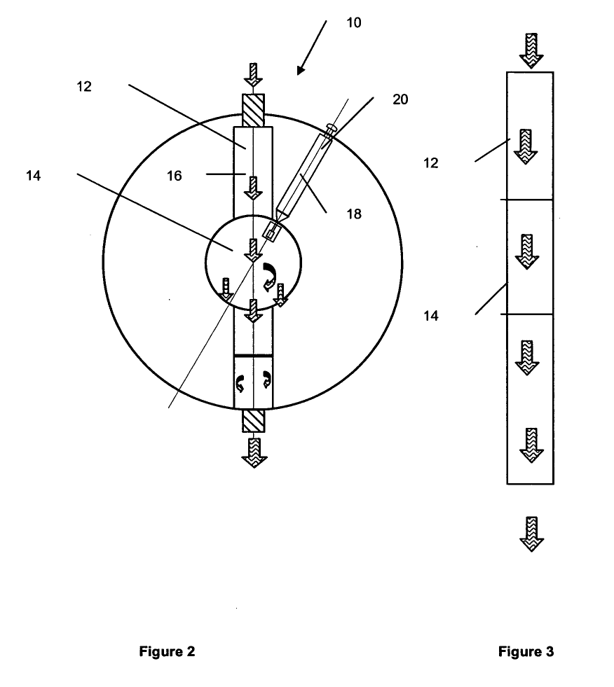

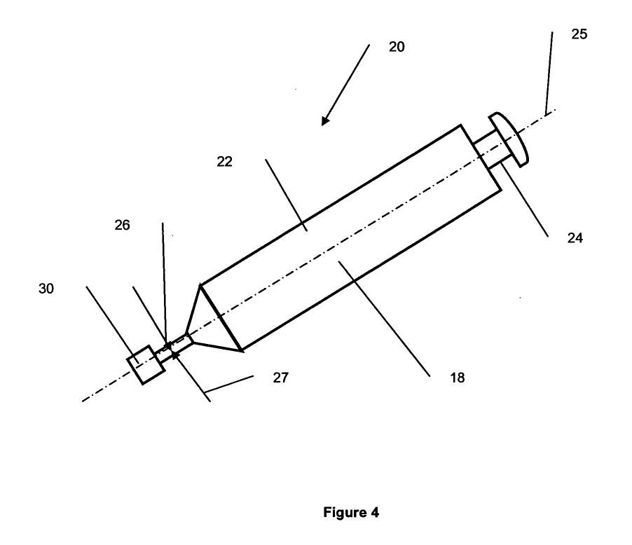

Referring to FIGS. 2 and 3, the apparatus 10 comprises a first fluid channel 12 in fluid communication with a mixing chamber 14 for mixing a fluid 16 with an agent 18. The mixing chamber 14 may be any space, part of a channel, compartment, cavity, channel, or the like that allows mixing. In this example, the fluid 18 is water for showering. However, the fluid 18 may be a gas such as air or pure oxygen. The mixing chamber 14 includes a dispenser 20 to dispense the agent 18 into the mixing chamber 14. The apparatus 10 may have a slot where the dispenser 20 may be detachably inserted into the mixing chamber 14. The agent 18 may be any fluid selected from a group consisting of: essential oils, hydrolates, fragrance oils, infused oils, perfumes and hydrosols.

FIG. 3 illustrates the flow of the water through the first fluid channel 12 and the mixed chamber 14.

An advantage of using the apparatus 10 is that taking a shower becomes more than just getting clean. A user may create his or her own personal aromatherapy experience by selecting the agent for mixing with the fluid in accordance to his or her moods or desires.

For example, to kick start the day, the user will not want to spend hours in the shower or bath. Therefore, the user may choose a dispenser 20 containing an essential oil such as peppermint, which has cooling and refreshing properties to stimulate the mind, increase mental agility and to increase focus. Similarly, at the end of a hard day's work, the user may choose to wind down by choosing a dispenser 20 containing an essential oil such as lavender, which has calming, and relaxing properties to combat stress.

FIG. 4 illustrates the dispenser 20 in detail. The dispenser 20 includes a container 22 for containing the agent 18, a plunger 24 and an outlet 26 wherein the agent 18 is dispensed from the dispenser 20. The plunger 24 is movable along a longitudinal axis 25 of the container 22. An absorbent member 30 is provided at the outlet 26 wherein the absorbent member 30 is in fluid communication or in contact, with the fluid 16 in the mixing chamber 14. The absorbent member 30 may be made of a material selected from a group consisting of: sponge, fabric, cotton, paper and absorbent polymers.

To dispense the agent 18, the plunger 24 is pressed and the agent 18 is dispensed into the mixing chamber 14 via the absorbent member 30. The agent 18 is introduced to the fluid 16 in the mixing chamber 14 via the absorbent member 30 by diffusion. An outlet diameter 27 is specified accordingly to facilitate dispensing but may prevent leaking of the agent 18 from the dispenser 20 when the plunger 24 is not pressed.

In an alternative embodiment, the dispenser dispenses the agent into the mixing chamber only when initiated by the user, i.e. by an electronic means or a mechanical means by pressing on, for example, a plunger. Advantageously, the water that exits the apparatus may or may not be mixed with the agent at the choice of the user.

The number of times the plunger 24 is pressed and/or the outlet diameter 27, determine a volume of the agent 18 dispensed. Alternatively, the agent 18 in the dispenser 20 may be dispensed into the mixing chamber 14 by an electronic means electrically connected to the apparatus 10. The electronic means may include an electronic timer and a presser electrically connected to the electronic timer to dispense the agent 18 into the mixing chamber 14 at predetermined intervals. The presser may be a mechanical lever or a mechanical plunger.

Alternatively, to accommodate users who wish to mix two or more agents 18 in their shower, the mixing chamber 14 may include a plurality of dispensers 20 (not shown) wherein each of the plurality of dispensers 20 dispenses a different agent. The dispensers 20 may contain agents 18 such as essential oils, hydrolates, fragrance oils, infused oils, perfumes (non-hazardous types), hydrosols, or the like. Preferably, only essential oils, infused oils, any hydrolates and hydrosols provide the therapeutic benefits are used as agents.

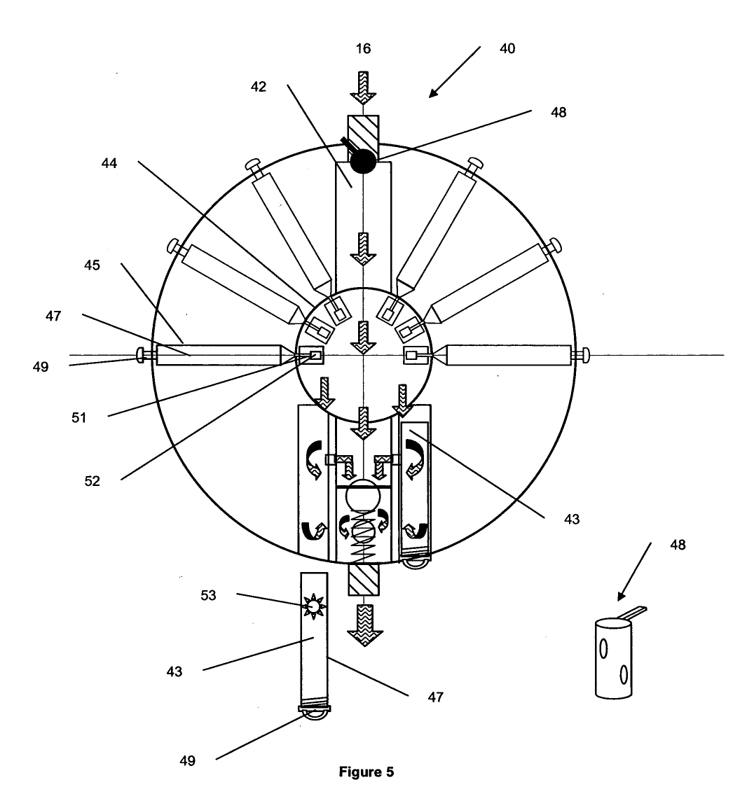

FIGS. 5, 6, 7 and 8 illustrate an apparatus 40 according to a second embodiment.

FIG. 5 is a top view of the apparatus 40. The apparatus 40 has a first fluid channel 42 in fluid communication with a mixing chamber 44 for mixing the fluid 16 with the agent 18. The mixing chamber 44 includes a plurality of dispensers 45 wherein each of the plurality of dispensers 45 dispenses a different agent when the dispensers are actuated or pressed individually or simultaneously. Similar to the mixing chamber 14 in the first embodiment, the mixing chamber 44 may also have only one dispenser 45.

Each dispenser 45 dispenses the agent 18 into the mixing chamber 44. Similar to the dispenser 20 in the first embodiment, the dispenser 45 includes a container 47 for containing the agent 18, a plunger 49 and an outlet 51 wherein the agent 18 is dispensed from the dispenser 45. An absorbent member 52 is provided at the outlet 51 wherein the absorbent member 52 is in fluid communication with the fluid 16 in the mixing chamber 44.

A difference between the apparatus 10 and the apparatus 40 is that the apparatus 40 further comprises a second fluid channel 46 and a fluid channel selector 48 to enable a user to select the flow of fluid to the first fluid channel 42 or the second fluid channel 46. The fluid channel selector 48 comprises a valve 54 about a fluid inlet 55 from a first position 103 to a second position 104 to select the flow of the fluid 16 from the fluid inlet 55 to the first fluid channel 42 or the second fluid channel 46.

The valve 54 may be operated manually, or electrically. For example, if the valve 54 is manually operated, the fluid channel selector 48 may include a handle 56 attached to the valve 54 for moving the valve 54 between the first position 103 and the second position 104. If the valve 54 is electrically operated, the fluid channel selector 48 may include an electronic control system electrically connected to a control button. The user may choose between mixed and non-mixed water by activating the control button. The valve 54 may be a switch valve, a ball valve, a butterfly valve or a plug valve or any such valve known in the art to achieve the function of selecting the flow of the fluid 16 from the fluid inlet 55 to the first fluid channel 42 or the second fluid channel 46. The valve 54 also prevents mixed fluid from exiting when the user only wants non-mixed fluid.

In religious rites or rituals or traditional medical remedies, a user may wish to add an agent 53 which is selected from a group consisting of: herbs, flowers, Epsom salts, shower salt, bath mixtures, activated carbon, vitamins. Therefore, the first fluid channel 42 may also includes a housing 43 to contain the agent 53 for mixing the fluid 16 with the agent 53.

A heating element may be incorporated into the apparatus 40 to heat the water to be mixed or introduced into the mixing chamber 44. Alternatively, the apparatus 40 may be incorporated into a water heater wherein the fluid 16 to be mixed or introduced into the mixing chamber 44 may be heated by the water heater. When the fluid 16, for example, hot water passes through the housing 43 containing the agent 53 such as for example, herbs, the hot water mixes with the herbs. The scent of the herbs is diffused into the running water to release a scented showering effect by submersion of the herbs in the water that flows through the housing 43. The herbs are retained in the housing 43 and the container 47 may be detached from the apparatus 40 for disposal of the herbs and for subsequent refills of agents 53. The housing 43 includes a container 47 and a cover 49 that encloses the container opening. The cover 49 may be screwed or plugged into the housing 43. Alternatively, the cover 49 may be snap-fit to the container 47 or form with the container 47 as one embodiment.

The first fluid channel 42 may be intermediate the fluid channel selector 48 and the mixing chamber 44. The first fluid channel 42 may further comprises a valve 58 at a fluid outlet 57 for preventing the agent or fluid mixed with the agent in the first fluid channel 42 from entering the second fluid channel 46. The valve 58 may be consists of an air-filled ball and a spring. Alternatively, instead of the air-filled ball, the valve 58 may comprise a stopper such as, for example, an inverted cone-shaped stopper. Alternatively, the valve 58 may be a flipping valve. Alternatively, the valve 58 may comprise a disc to direct fluid flow through the valve 58.

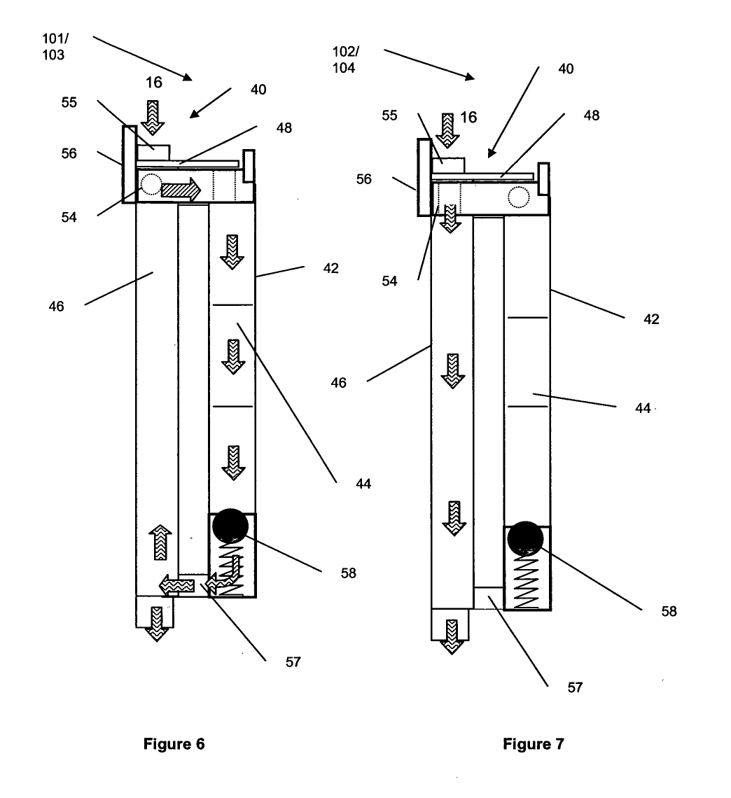

FIGS. 6 and 7 show the flow of water in the apparatus 40 in a mixed fluid mode 101 and a non-mixed fluid mode 102 respectively. In FIG. 6, when the user selects the mixed fluid mode 101, the valve 54 opens to allow the fluid 16, for example, water to flow into the first fluid channel 42 to the mixing chamber 44 and prevents direct water flow to channel 46. In the mixing chamber 44, the absorbent member 52 with the agent 18 absorbed within is in contact with the water 16 in the mixing chamber 44. The action of the running water 16 in the mixing chamber 44 enables the agent 18 to mix with water 16. The force of the flowing mixed water pushes through the valve 58 to flow through the fluid outlet 57, out of the shower head 4 and provide mixed flow to the user. This creates a showering effect similar to an experience in a spa, which aromatically relaxes or stimulates the user. This showering effect also helps the user to relax, stimulates the immune system and the user is able to experience other desired beneficial properties of spas or aromatherapy depending on the selected agent 18 or 53.

After showering in the mixed fluid 101, the user may decide to have a non-mixed shower to rinse off the residual essential oil on the user's body. One advantage of the apparatus 40 is that the user need not use a separate shower device to have a non-mixed shower. In FIG. 7, when the user selects to shower with non-mixed fluid, such as water only, the user selects the non-mixed fluid mode 102 accordingly. The valve 54 opens to allow the fluid 16, water, to flow into the second fluid channel 46 and prevent water flow to channel 42. Without the force of water flowing through the first fluid channel 42, the valve 58 closes the fluid flow to outlet 57 and prevents the agent 18 or fluid mixed with the agent 18 in the first fluid channel 42 from entering the second fluid channel 46.

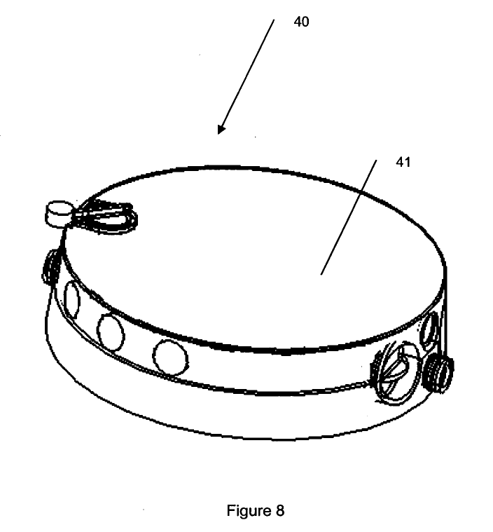

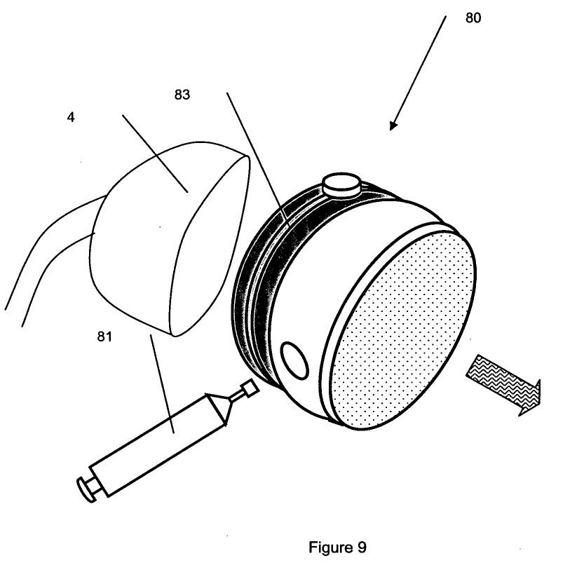

FIG. 8 is a perspective view of the apparatus 40 when the apparatus is covered with a cover 41.

FIG. 9 shows an apparatus 80 according to a third embodiment in use in the conventional showering unit 2. Dependent on the user's needs and application, the apparatus 80 is similar to the apparatus 10 or the apparatus 40. In addition, the apparatus 80 comprises a plug 83 adapted to latch over the shower head 4. The plug 83 may have a latching mechanism such as a catch on its periphery for attaching over the shower head 4. Other latching mechanisms may be for example, a screw knob, a screw type latch, a grip type latch or the like. The plug 83 may be found of a flexible waterproof material such as for example, silicone, rubber, synthetic polymer or the like.

The advantage of the apparatus 80 is that there is no need for an additional hose. This may provides mobility, to be use anywhere, in public washrooms or in circumstances where the shower-units outlets are tight fitted or embedded. The apparatus 80 may also be applied in kitchen faucets where the apparatus 80 comprises dispensers 81 similar to the dispensers 20, 45 for containing liquid detergent for washing.

The inlet of the apparatus 80 may be attached to one end of a hose. In an alternative embodiment, a shower head 4 may be attached to another end of the hose.

The present invention may also be used in applications such as for example:
i. Aromatherapy where essential oils or hydrosols are mixed while showering. Individual essential oils provide beneficial properties such as enhancement and balancing of immune system, relaxation, anti-stress, anti-insomnia, anti-bacteria, anti-virus, anti-viral, and as an insect-repellant. Hydrosol, which is a part of the plant where its essences are distilled to obtain essential oils. It is water based which is smoother and more friendly for users who are hyper-sensitive or have a history of allergies;
ii. For religious rites or rituals, where the user can mix compounds commonly used for religious purposes such as for example, flowers with water for showering;
iii. Salts bath where sea salts or Epsom salts baths are mixed with water; and
iv. Herbal or floral showers for refreshing or therapy properties;
v. Hydro-therapy for relaxation; and
vi. Shampoo, showering lotions and the like

In all embodiments, the apparatus 10, 40, 80 may be connected for use in a gas unit, gas tanks or oxygen tanks instead of the shower unit 2 where the fluid 16 may a gas, or pure oxygen.

In all embodiments, the apparatus 10, 40, 80 may be incorporated into a water heater such as for example, an instant water heater. Alternatively, a heating element may be incorporated into the apparatus 10, 40, 80 to heat the fluid or water to be mixed or introduced into the mixing chamber 14, 44. Heated water may then be mixed in the mixing chamber 14, 44.

Whilst there has been described in the foregoing description preferred embodiments of the present invention, it will be understood by those skilled in the technology concerned that many variations or modifications in details of design or construction may be made without departing from the present invention.

1. An apparatus for facilitating mixing of a fluid, the apparatus comprising a first fluid channel in fluid communication with a mixing chamber for mixing the fluid with an agent, wherein the mixing chamber includes a dispenser to dispense the agent into the mixing chamber, the dispenser includes an absorbent member for containing the agent dispensed by the dispenser, the absorbent member in contact with the fluid in the mixing chamber.

2. The apparatus according to claim 1, wherein the apparatus further comprises a second fluid channel and a fluid channel selector to select the flow of fluid to the first or second fluid channel.

3. The apparatus according to claim 1, wherein the apparatus further comprises a heating element to heat the fluid to be mixed or introduced into the mixing chamber.

4. The apparatus according to claim 3 wherein the fluid channel selector is a valve about a fluid inlet from a first position to a second position, the first position allows fluid flow to the first fluid channel and the second position allows flow to the second fluid channel.

5. The apparatus according to preceding claim 1 wherein the first fluid channel is intermediate the fluid channel selector and the mixing chamber.

6. The apparatus according to claim 1, wherein the absorbent member is made from a material selected from the group consisting of: sponge, fabric, cotton, paper and absorbent polymers.

7. The apparatus according to claim 1, wherein the agent in the dispenser is dispensed into the mixing chamber by an electronic means.

8. The apparatus according to claim 7, wherein the electronic means comprises a timer and a presser electrically connected to the timer to dispense the agent at predetermined intervals.

9. The apparatus according to claim 1, wherein the mixing chamber comprises a plurality of dispensers, each dispenser dispenses a different agent.

10. The apparatus according to claim 1, wherein the agent is selected from the group consisting of: essential oils, hydrolates, fragrance oils, infused oils, perfumes and hydrosols.

11. The apparatus according to claim 1 wherein the first fluid channel further comprises a valve for preventing the agent or fluid mixed with the agent in the first fluid channel from entering the second fluid channel.

12. The apparatus according to claim 1, wherein the apparatus is releasably attached to a shower head, and fluid enters the apparatus from the shower head.

13. The apparatus according to claim 1, wherein an outlet of the apparatus is releasably attached to a shower head.

14. The apparatus according to claim 13, wherein the outlet of the apparatus is releasably attached to a shower head by a hose.

15. The apparatus according to claim 1, wherein the first fluid channel comprises a housing to house an agent for mixing with the fluid.

16. The apparatus according to claim 15, wherein the agent is selected from a group consisting of: herbs, flowers, Epsom salts, shower salt, bath mixtures, activated carbon, vitamins.

17. The apparatus according to claim 16, wherein the agent is retained in the housing when the fluid flows through the housing.

18. The apparatus according to claim 1, wherein the first fluid channel and the mixing chamber are integrally formed.

19. The apparatus according to claim 1, wherein the apparatus is incorporated into a water heater to heat the fluid to be mixed or introduced into the apparatus.

20. An apparatus for facilitating mixing of a fluid, the apparatus comprising a first fluid channel in fluid communication with a mixing chamber for mixing the fluid with an agent, wherein the mixing chamber includes a dispenser to dispense the agent into the mixing chamber and the agent is dispensed into the mixing chamber by an electronic means.

21. An apparatus according to claim 20, wherein the electronic means comprises a timer and a presser electrically connected to the timer to dispense the agent at predetermined intervals.

22. A method for providing a shower comprising:
choosing at least one dispenser, where the dispenser includes a container containing an agent;
dispensing the agent into a mixing chamber via an absorbent member;
introducing fluid into the mixing chamber so that the fluid mixes with the agent in the absorbent member by diffusion; and
providing flow of the mixed fluid via a shower head.
